(19) United States
(12) Patent Application Publication
(10) Pub. No.: US 2002/0140495 A1
(43) Pub. Date: Oct. 3, 2002

(54) Method for increasing the supply voltage range of an integrated circuit

(75) Inventors: Ulrich Wicke, Heilbronn (DE); Martin Berhorst, Heilbronn (DE)

Correspondence Address: FASSE PATENT ATTORNEYS, P.A., P.O. BOX 726, HAMPDEN, ME, 04444-0726, US

(73) Assignee: ATMEL Germany GmbH, Heilbronn (DE)

(21) Appl. No.: 10/057,577

(22) Filed: Jan. 24, 2002

(30) Foreign Application Priority Data
Mar. 27, 2001 (DE) 101 15 100.4

(51) Int. Cl. H02J 1/00

(52) U.S. Cl. 327/530

(57) ABSTRACT

Method for increasing the supply voltage range of an integrated circuit. In the previously known methods, the electrical parameters of an integrated circuit are adapted to the intended supply voltage during manufacture. With the new method, the electrical parameters are adapted to the supply voltage by an integrated control circuit. This control circuit adapts or compensates the change of the electrical parameters caused by a change of the supply voltage by means of one or a plurality of switching elements.

### BACKGROUND

### FIELD OF THE INVENTION

The present invention relates to a method for increasing the supply voltage range of an integrated circuit according to the preamble of patent claim 1.

Such a method is known from the publication U.S. Pat. No. 5,825,166. In this, a reference voltage, which is fed to an analog circuit component and a digital circuit component, is generated as a function of an available supply voltage by means of a supply voltage unit in order to thus set internal voltage references in individual circuit blocks. The disadvantage of this is that the reference voltage is generated by means of a very costly, so-called mixed signal circuit.

In order to reduce the power consumption of integrated circuits, ever lower supply voltages are applied to the circuits. However, at the same time, there is a demand for the integrated circuits to be able to be used with as many different low supply voltages as possible. In so doing, the high degree of complexity and the ever higher input sensitivities make it important for the integrated circuits to be able to be used with various supply voltages. An important area of application of such integrated circuits is the field of infrared data transmission.

Known integrated circuits are aligned according to the supply voltage in the manufacturing process. A subsequent change or adaptation to the supply voltage is not possible. Examples of such circuits are the T2548B and T2524B circuits from the company ATMEL Germany GmbH. According to the specifications in the data sheets, each of these circuits is used for one supply voltage only.

### SUMMARY OF THE INVENTION

The object of the present invention is to provide a method by which circuits can be operated with various supply voltages. A further object of the invention is to specify a circuit arrangement for implementing the method which can be easily and economically manufactured.

The first-named object of the invention is solved by the features described in patent claim 1. The circuit arrangement is solved by the features of patent claim 5. Favorable embodiments are the objects of subclaims.

The essence of the invention is to set, in a reversible manner, selected electrical parameters for an integrated electrical circuit as a function of the magnitude of an externally available supply voltage without a manual alignment. For this purpose, a control signal is generated by a control unit corresponding to the magnitude of the supply voltage, with which at least one switching element is controlled, and thus one or a plurality of electrical parameters of the integrated circuit are set.

In an advantageous development of the method, the electrical parameters of the integrated circuit are set, in that one or a plurality of components are switched in or bridged by one or a plurality of switching elements. For this purpose, the switching elements are arranged in parallel or in series to the components which are to be switched. A further option is to link potentials at circuit nodes to a reference potential by means of the switching elements, or to switch circuit elements so that they are in parallel.

Investigations by the applicant have shown that it is advantageous if the switching in or bridging of the components is performed within the integrated circuit by means of one or a plurality of MOS transistors. As a result of the loss-free control of the MOS transistors, the integrated circuit is little influenced by the switching elements. Particularly when a plurality of MOS transistors are connected as a transmission gate, the electrical parameters are especially little influenced by the additional switching elements because of the low residual voltage and the small residual resistance. In this manner, electrical parameters, such as the quality of filters, the rise time of signals and operating points of circuit elements, can easily be set by circuit elements. In particular, the changes in electrical parameters of a circuit resulting from the change in the supply voltage can be compensated.

### BRIEF DESCRIPTION OF THE FIGURES

The method according to the invention is described in the following by means of the embodiments in conjunction with the drawings. They show:

FIG. 1 a first circuit arrangement for implementing the method according to the invention, and

FIG. 2 an embodiment as a method for setting the operating point, and

FIG. 3 an embodiment as a method for setting the charging time of a capacitor.

### DESCRIPTION OF THE PREFERRED EMBODIMENTS

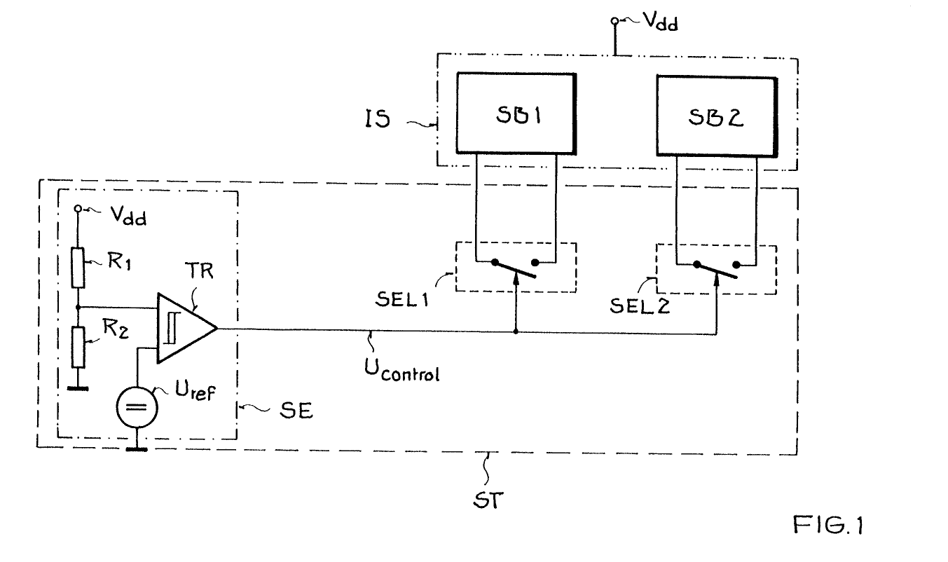

The integrated circuit arrangement illustrated in FIG. 1 sets two electrical parameters, such as, for example, the operating point of a transistor or the rise time of an output voltage of an integrated circuit component IS, by means of an additional integrated control circuit ST as a function of the magnitude of an available supply voltage Vdd. Such a circuit is used in infrared data transmission as a receiver circuit for example. The structure of the control circuit ST is explained in the following.

The control circuit ST consists of a control unit SE, a first switching element SEL1 that is linked to a first circuit unit SB1, and a second switching element SEL2 that is linked to a second circuit unit SB2. Furthermore, the control unit SE consists of a resistor R1 that is linked to a supply voltage Vdd, and a resistor R2 that is linked to a reference potential. The two resistors R1, R2 form a voltage divider, the output of which is linked to a first input of an inverting Schmitt trigger TR. A reference voltage source Uref is connected to a second input of the Schmitt trigger TR. The output of the Schmitt trigger TR, at which a control voltage Ucontrol is available, is linked to a control input of the first switching element SEL1 and to a control input of the second switching element SEL2.

The principle of operation of the circuit arrangement is described in the following, in which in a first operating case the supply voltage Vdd is substantially lower than in a second operating case.

In the first operating case, the voltage of the voltage divider available at the first input of the Schmitt trigger TR is lower than the switching voltage of the Schmitt trigger TR, that is the value of the control voltage Ucontrol available at the output of the Schmitt trigger TR is “low” and both switching elements SEL1 and SEL2 are closed. The respective electrical parameters are changed both in the circuit unit SB1 and in the circuit unit SB2.

In the second operating case, the voltage of the voltage divider available at the first input of the Schmitt trigger TR is higher than the switching voltage of the Schmitt trigger TR, that is the value of the control voltage Ucontrol available at the output of the Schmitt trigger TR is “high” and both switching elements SEL1 and SEL2 are open. The respective electrical parameters retain their preset values, both in the circuit unit SB1 and in the circuit unit SB2.

The hysteresis of the Schmitt trigger TR ensures that a stable operating state is maintained in the case of supply voltages which lie in the middle of the two switching voltages of the Schmitt trigger TR. Furthermore, the illustrated circuit arrangement can be expanded by additional Schmitt triggers controlling additional switching elements and thus setting additional electrical parameters or setting one electrical parameter several times.

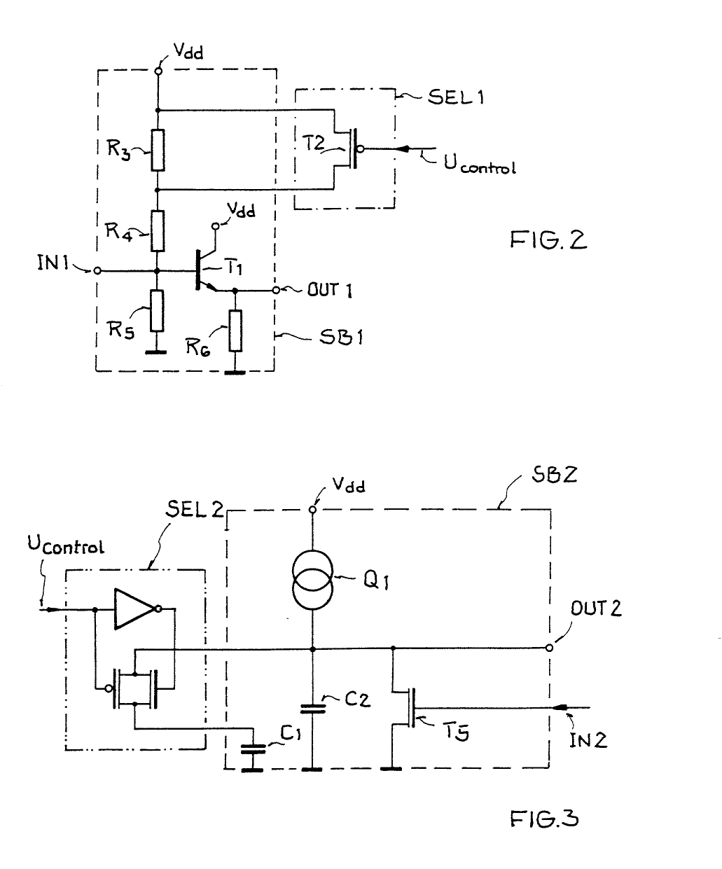

The embodiment shown in FIG. 2 sets the operating point of the circuit unit SB1 as a function of an available supply voltage Vdd. For this purpose, a PMOS transistor T2 is used as the switching element SEL1. The control voltage Ucontrol available at the gate of the transistor T2 is generated in accordance with the explanations concerning the embodiment shown in FIG. 1.

The circuit of the circuit unit SB1 is explained in the following. A resistor R3 lying at the supply voltage Vdd and a resistor R4 lying in series, together with a resistor R5 connected to the reference potential, form a voltage divider. The output of the voltage divider is linked to the base of a transistor T1 to which a signal input IN1 is connected at the same time. The transistor T1 is arranged in a common emitter stage, that is an output signal OUT1 is accessed via a resistor R6 lying in the emitter branch of the transistor T1.

The principle of operation of the circuit unit SB1 is explained in the following. If the control voltage Ucontrol available at the gate of transistor T2 is “low”, the transistor T2 is closed and the resistor R3 lying in parallel to transistor T2 is bridged. As the transistor T2 has only a very low residual voltage, the operating point of the transistor T1 is determined at low supply voltages by the voltage divider consisting of R4 and R5. If the control voltage Ucontrol available at the gate of transistor T2 is “high”, the transistor T2 is open, and the series connection of R3 and R4, together with the resistor R5, form the voltage divider. The operating point of the transistor T1 is thus lowered at higher supply voltages.

The embodiment shown in FIG. 3 sets the rise time as a function of the available supply voltage Vdd. For this purpose, the capacity of the circuit unit SB2 is raised or lowered by the switching element SEL2, which is designed as a so-called transmission gate, connecting the capacitor C1 to or separating it from the circuit unit SB2. The control voltage Ucontrol available at the switching element SEL2 is generated in accordance with the explanations concerning the embodiment shown in FIG. 1.

The circuit of the circuit unit SB2 together with its principle of operation are explained in the following. A current source Q1 connected to the supply voltage Vdd charges a capacitor C2 linked to the reference potential. At the same time, the charging voltage of the capacitor C2 determines the output voltage OUT2 of the circuit unit SB2. Furthermore, the capacitor C2 is discharged by means of a transistor T5 linked to the reference potential provided that an input signal IN2 with the value “high” is available at the control input of the transistor T5. Also, the transmission gate connects or separates a capacitor C1 to or from the circuit unit SB2 as a function of the value of the available control voltage Ucontrol. If the control voltage Ucontrol is “high”, the transmission gate separates the capacitor C2 from the circuit unit SB2, and the rise time of the output voltage OUT2 is lowered. If the control voltage Ucontrol is “low”, the capacitor C2 is switched in parallel to the capacitor C1, and the rise time of the output voltage OUT2 is increased. As a result of the low residual voltage and the very low residual resistance of the transmission gate, the rise time of the output voltage OUT2 is substantially determined by the two capacity values of the capacitors C1 and C2.

What is claimed is:

1. Method for increasing the supply voltage range of an integrated circuit (IS) in which
a control signal (Ucontrol) is generated as a function of the magnitude of the available supply voltage (Vdd), and
a switching element (SEL1, SEL2) is controlled by the control signal (Ucontrol),
wherein
at least one electrical parameter of the integrated circuit (IS) is set by means of the switching element (SEL1, SEL2).

2. Method according to claim 1, wherein the operating point of a component of an integrated circuit (IS) is set as an electrical parameter.

3. Method according to claim 1, wherein at least one component of the integrated circuit (IS) is switched in or bridged in order to set the electrical parameters.

4. Method according to claim 2, wherein the switching or bridging is performed by means of one or a plurality of MOS transistors.

5 (cancelled)

6 (cancelled)

7. (new) Control circuit (ST) for an integrated circuit (IS) for generating a control signal (Ucontrol) with a control unit (SE) and a switching element (SEL1, SEL2) for performing the method according to claim 1, wherein
the control unit (SE) has a voltage divider which is linked to a first input of a Schmitt trigger (TR), and a reference voltage source (Uref) which is linked to a second input of the Schmitt trigger (TR), and the output of the Schmitt trigger (TR) is linked to a switching element (SEL1, SEL2), and
the switching element (SEL1, SEL2) is linked to at least one component of the integrated circuit (IS).

8. (new) Control circuit (ST) according to claim 7, wherein the switching element (SEL1, SEL2) is linked in series or parallel to at least one component of the integrated circuit (IS).
